(19) United States
(12) Patent Application Publication
(10) Pub. No.: US 2024/0095477 A1
(43) Pub. Date: Mar. 21, 2024

(54) CODE READER, CODE READING SYSTEM, WORK SYSTEM AS WELL AS METHOD

(71) Applicant: Workaround GmbH, Munchen (DE)

(72) Inventors: Suzana TASIC, Belgrad (RS); Damjan NOVAKOVIC, Priboj (RS)

(21) Appl. No.: 18/370,429

(22) Filed: Sep. 20, 2023

(30) Foreign Application Priority Data
Sep. 21, 2022 (DE) 10 2022 124 303.6

(51) Int. Cl. G06K 7/10; G06K 7/14

(52) U.S. Cl. CPC G06K 7/10396; G06K 7/1417

(57) ABSTRACT

A code reader for attachment to a garment including a reader unit, a control unit as well as a communication module for wireless data transmission. The reader unit, the control unit and the communication module have wired connections to each other. The reader unit is configured to scan a code, to decode the scanned code into a character string and to transfer the character string to the control unit. The control unit includes at least one test condition and is configured to receive the character string, to compare the character string with said at least one test condition, and to execute an action depending on the result of the comparison. Moreover, a wearable code reading system, a work system and a method are shown.

### FIELD OF THE DISCLOSURE

The disclosure relates to a code reader, a wearable code reading system, a work system as well as a method for operating a work system.

### BACKGROUND

Work systems are known in which the users of the work system are equipped with a code reading system, e.g. from DE 10 2020 106 369. By means of the code reading system, the users scan codes for specific process steps and receive feedback from a control system as to whether the scanned code corresponds to the expected code of the process to be executed.

For example, if goods are to be collected and packed for dispatch, a code corresponding to the good to be dispatched is initially expected by the control system. Subsequently, a code is expected that belongs to a packing container.

The processes executed with such work systems are however extremely complex and contain a plurality of codes and branches that need to be tested. Accordingly, latencies arise between the executed reading process of a code and the output of feedback to the user by the code reading system as to whether the code scanned last corresponds to the expectations of the control system or not. These latencies result in user waiting times and thus in inefficiencies in the work system.

### SUMMARY

Thus, there is provided a code reader, a wearable code reading system, a work system as well as a method in which the user is given feedback immediately.

For this purpose, a code reader for attachment to a garment, in particular a glove, is provided comprising a reader unit, a control unit as well as communication module for wireless data transmission. The reader unit and the control unit as well as the control unit and the communication module have wired connections to each other. The reader unit is configured to scan a code, to decode the scanned code into a character string and to transfer the character string to the control unit. The control unit comprises at least one test condition and/or one set of test conditions and is configured to receive the character string, to compare the character string with said at least one test condition, and to execute an action depending on the result of the comparison.

Due to the fact that the character strings of the scanned codes are already compared in the code reader by means of the test conditions, it is no longer necessary to wait for a response of the control system in order to give the user feedback. Instead, feedback can already be given to the user based on the comparison that the control unit executed itself in the code reader. This results in immediate feedback so that waiting times are avoided.

A character of the character string may be a letter, a digit, punctuation, or any other valid character.

A set of test conditions comprises, for example, at least two test conditions.

In particular, the test conditions are specified by a device other than the code reader and/or are, in particular, codes that have not been scanned previously.

In particular, the reader unit for scanning codes is configured to generate at least one recording of its field of view and to detect at least one code in the recording. For example, the reader unit transmits one character string each per code.

The reader unit and the control unit can be different units, in particular different hardware units.

The reader unit and the control unit can be designed on different chips or together as a module (e.g. a “system on a module”/SOM).

It is also conceivable that the reader unit and the control unit are designed jointly, in particular that a decoder of the reader unit is integrated into the control unit, or the control unit executes the tasks of the decoder. The control unit receives in this case the recordings of a camera of the reader unit.

In an embodiment, the action comprises one or more of the following activities:
sending the entire character string, a part of the character string, an entire further character string that has been received by the reader unit, and/or a part of a further character string by means of the communication module;
discarding the character string and/or a further character string that has been received by the reader unit;
adapting the character string and/or a further character string and sending the adapted character string by means of the communication module, in particular replacing one or more specific characters at a specific position in the character string; or
sending an instruction to the reader unit to end or to continue a reading process.

In this way, decisions on the further processing of the character string can already be met at a particularly early point in time, thereby improving the process further.

A further character string is understood to mean, in particular, another character string that is transmitted to the control unit in the same reading process.

The adaption of the character string comprises, for example, the removal and/or addition of characters at a specific position in the character string, e.g. the removal and/or the addition of a specific number of characters from the start and/or the end of the character string.

The entire character string or an adapted character string may be send individually by means of the communication module. It is also conceivable that in order to send the entire character string and/or an adapted character string by means of the communication module, several character strings to be sent are sent jointly, for example together in a single transport character string.

For example, a transport character string comprises several character strings to be sent that are concatenated to each other. It is possible that between two character strings to be sent in the transport character string no, one or more than one additional characters are provided or added, which separate the character strings to be sent from each other.

To do so, it is conceivable that the associated at least one test condition specifies how the character string or character strings are to be sent, for example whether the character strings to be sent are to be sent individually or together in a transport character string, and/or whether and which additional characters are to be added between the character strings.

A sequence, as described below, may be taken into account.

The control unit can be configured to generate a corresponding transport character string.

To test efficiently, said at least one test condition can specify at least one property of the character string, in particular one or more specific characters at a specific position in the character string and/or the length of the character string.

For example, the test condition solely specifies one or more properties of the character string, in particular one or more specific characters at a specific position in the character string and/or the length of the character string.

In an embodiment, said at least one control unit is configured to compare said at least one test condition via character comparison of the character string with the test condition, thereby enabling testing in a way that conserves resources.

For example, the comparison occurs solely using a comparison of the character string.

To be capable of classifying specific situations precisely, several test conditions can be grouped together into different groups of test conditions and/or a sequence can be stored in the control unit in which the test conditions and/or groups of test conditions are to be tested.

In an embodiment, the control unit is configured to receive at least one further test condition and/or action and/or a further set of test conditions by means of a communication module. In this way, the test can be adapted to the current application of the code reader.

Said at least one further test condition, action or set of test conditions replaces or supplements test conditions, actions or the set of test conditions already present in the control unit.

To undertake targeted actions, the action can be part of the set of test conditions and/or can be stored together with the associated test condition in the control unit.

In an embodiment, the code reader is a one-piece device and/or the code reader comprises a housing in which the code reader and the control unit are located, thereby obtaining a particularly compact device.

In an embodiment, the control unit is configured to scan several codes after activation of a reading process, in particular continuously, to decode the scanned codes each into a character string and to transfer the character strings to the control unit. In this way, several codes can be scanned and processed quickly.

A character string that chronologically follows or precedes a character string can be regarded as a “further character string”.

So that the character strings transmitted by the code reader could be processed more easily by a subsequent system, such as a control system, one of the actions and/or the set of test conditions can define a sequence in which character strings are to be sent by means of the communication module, and the control unit can be configured to send the character strings in that sequence.

To save energy, the reader unit can be configured to start a reading process after receiving a user input.

In an embodiment, the code reader comprises an output means, in particular a loudspeaker, a screen and/or a vibration motor, wherein the control unit is configured to output as an action an output to the user by means of the output means, thereby already providing the user with feedback via the code reader itself.

It is also conceivable that the user receives feedback via another device that is separate to the code reader.

Moreover, for above mentioned purpose, a wearable code reading system is provided, comprising a garment, in particular a glove, and a code reader as described previously, wherein the garment comprises a holder for the code reader.

The features and advantages described for the code reader apply equally to the wearable code reading system and vice versa.

In particular, the code reader is inserted into the holder.

In an embodiment, the garment comprises an input means that is connected to the code reader and the code reader is designed to receive actuations of the input means as inputs, thereby making the operation of the code reader extremely ergonomic.

The connection between the code reader and the input means occurs, for example, electronically by means of a cable integrated into the garment.

For above mentioned purpose, there is further provided a work system comprising a code reader as described previously and a control device, wherein the work system is configured so that the code reader sends a character string to the control device by means of the communication module.

The features and advantages described for the code reader and/or the wearable code reading system equally apply to the work system and vice versa.

For example, the control device is a control system, in particular a server, and/or a connection device, in particular a wearable smart device, in particular a smartphone, a tablet, a laptop, a smart watch or smart glasses.

To adjust the test by the code reader to the current application of the code reader, the control device can be configured to transmit individual test conditions, actions and/or a set of test conditions to the code reader, and the code reader can be configured to consult the received test condition and/or the received set of test conditions for the comparison.

In an embodiment, the work system comprises a garment, in particular a glove, which has an input means for the code reader, in particular wherein the input means comprises a trigger that is connected to the code reader and the code reader is designed to receive actuations of the trigger as inputs. As a result, the code reader can be operated extremely ergonomically.

For above mentioned purpose, there is further provided a work system comprising a code reader for attachment to a garment and a control device that is a connection device. The code reader comprises a reader unit as well as communication module for wireless data transmission, wherein the reader unit is configured to scan a code, to decode the scanned code into a character string and to send the character string to the control device by means of the communication module, and/or wherein the reader unit is configured to scan a code and to send the scanned code to the control device by means of the communication module. The control device comprises at least one test condition and/or one set of test conditions and is configured to receive the character string and/or to receive the scanned code and to decode the scanned code into a character string, to compare the character string with at least one test condition, and to execute an action depending on the result of the comparison.

It has been found that waiting times or latencies can also be reduced by the test in the connection device.

The features and advantages described for the code reader, the wearable code reading system or the preceding work system apply equally or correspondingly to the work system and vice versa, in particular such features and advantages that further describe the actions, the test conditions, the set of test conditions, the reader unit and/or the control device. For example, the dependent claims also specify further embodiments of the work system.

Moreover, for above mentioned purpose, there is further provided a method for operating a code reader, in particular as described previously and/or a work system, in particular as described previously, wherein the method comprises the following steps:
a. scanning of a code, decoding of the scanned code into a character string and transfer of the character string to the control unit by the reader unit,
b. receipt of the character string by the control unit.
c. comparison of the character string with at least one test condition via the control unit, wherein said at least one test condition and/or a set of test conditions is stored in the control unit, and
d. execution of an action by the control unit depending on the result of the comparison.

The features and advantages described for the code reader, the wearable code reading system and/or the work system equally apply to the method and vice versa.

The steps, for which the code reader, the wearable code reading system and/or the work system and the components thereof are designed, can similarly be steps of the method and vice versa.

### BRIEF DESCRIPTION OF THE DRAWINGS

Additional advantages and features of the disclosure can be found in the following description and in the attached drawings to which reference is made. In the drawings:

FIG. 1 shows a work system according to an embodiment of the disclosure comprising a wearable code reading system according to an embodiment of the disclosure comprising a code reader according to an embodiment of the disclosure in a schematic view,

FIG. 2 shows the code reader according to FIG. 1 in an enlarged view,

FIG. 3 shows a flow diagram of a method according to the disclosure using the work system according to FIG. 1,

FIG. 4 shows a section of a part on which several codes are placed, and

FIG. 5 shows an exemplary set of test conditions.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

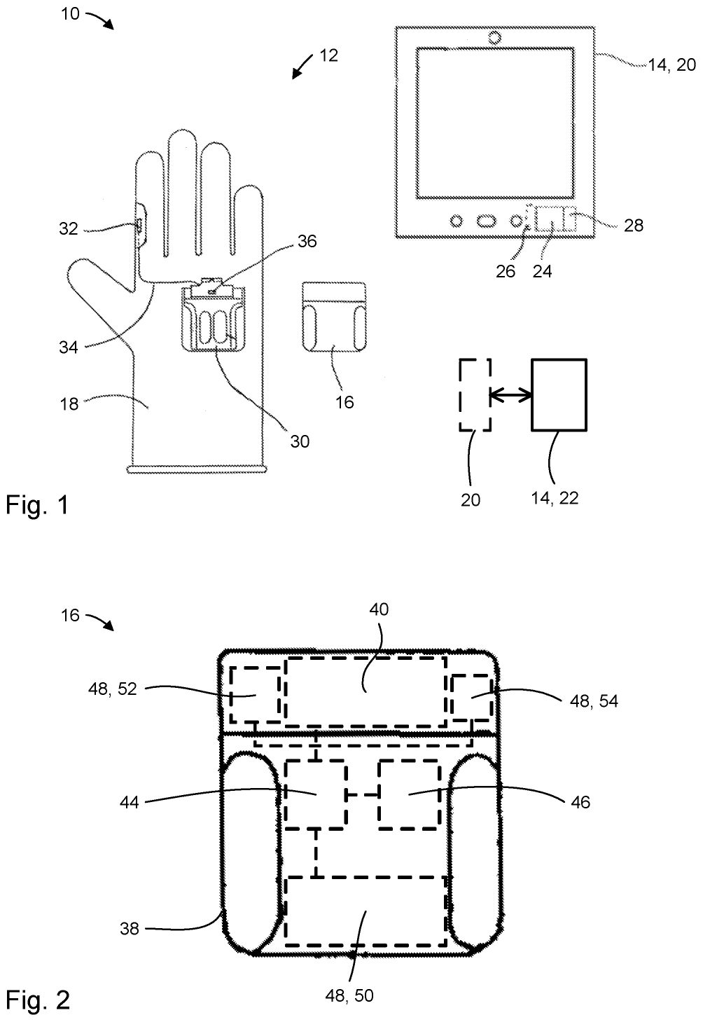

FIG. 1 shows a work system 10 schematically that comprises a wearable code reading system 12 and a control device 14.

The code reading system 12 comprises a code reader 16 and a garment 18, in the shown embodiment a glove.

The code reading system 12 thus represents a sensor system and is designed for industrial use. It is therefore suitably robust for continuous operation.

The work system 10 also comprises a connection device 20 and a control system 22 that constitutes the control device 14 individually or in conjunction with each other.

The connection device 20 is a wearable smart device, preferably a smartphone. However, the connection device 20 can also be, for example, a tablet, a laptop, a smart watch or smart glasses.

In principle, the connection device 20 can also be a stationary connection device, for example a stationary computer, also referred to as a gateway (represented as dashed lines).

The connection device 20 has a control unit 24 comprising a first communication module 26 and a second communication module 28.

The first communication module 26 is designed to communicate with the control system 22. The first communication module 26 is, for example, a WLAN module or a LAN module.

The second communication module 28 is designed to communicate with the code reader 16 wirelessly. For example, the second communication module 28 is designed to communicate with the code reader 16 via short-range radio technology, such as Bluetooth, in particular Bluetooth Low Energy, or via WLAN.

The control system 22 is, for example, a server on which the corresponding software is executed, such as an enterprise resource planning system (ERP system), for example on a local server or a cloud server.

The code reader 16 is attached to the body of the user by means of the garment 18. The wearable code reading system 12 is thus what is termed a “wearable”.

For this purpose, the garment 18 has a holder 30 in which the code reader 16 can be attached and removed, in particular, in a repeatable manner without tools.

The garment 18 can also have an input means 32, for example a trigger for the code reader 16. The trigger or the input means 32 can be provided on a finger of the glove. It is also conceivable that said at least one input means 32 or one or several further input means 32 are provided on the holder 30.

By means of at least one cable 34 and at least one contact 36 in the holder 30, the input means 32 is connected to the code reader 16 as soon as it is inserted in the holder 30.

In FIG. 2, the code reader 16 is shown enlarged. For example, the code reader 16 is not a multi-functional device, thus not a smart device, such as a smartphone, a tablet, a smart watch or smart glasses.

The code reader 16 has a housing 38, a reader unit 40, a control unit 44 comprising a communication module 46, several output means 48 and a power storage medium, such as a storage battery.

For example, the code reader 16 comprises as output means 48 a screen 50, a loudspeaker and a vibration motor 54 which are attached in or on the housing 38.

The screen 50 can be designed as an input means alternatively or in addition to the input means 32 on the garment 18. For example, the screen 50 is designed as a touch display.

The reader unit 40 and the control unit 44 are separate units, in particular separate hardware units that are connected to each other via a wired-connection for the purpose of data exchange.

The reader unit 40 and the control unit 44 can be designed on different chips or together as a module (e.g. a “system on a module”/SOM).

It is also conceivable that the reader unit 40 and the control unit 44 are designed jointly, in particular that a decoder of the reader unit 40 is integrated into the control unit 44 or the control unit 44 executes the tasks of the decoder. The control unit 44 receives in this case the recordings of the camera of the reader unit 40.

The control unit 44 also communicates via wired connection with the communication module 46 and the output means 48.

The reader unit 40 and the control unit 44 are located in the housing 38. Similarly, the power storage medium is attached to the housing 38.

In the shown embodiment, the code reader 16 is a one-piece device, i.e. it consists solely of the components attached in and on the housing 38.

The reader unit 40 is a unit for scanning machine-readable codes. For example, the reader unit is the camera module SE4750 from Zebra Technologies Corp. comprising the decoder PL5000.

The reader unit 40 is designed and configured in a known manner to generate at least one recording of its field of view, to detect at least one code in the recording, to decode the scanned or detected code into a character string and to output the character string.

For example, the reader unit 40 comprises a decoder and a camera module, wherein the decoder receives the recordings taken by a camera of the camera module, scans the codes therein and decodes these into character strings that under certain circumstances at this point in time and in the transmission to the control unit is not present as the variable of the “string” type, but rather as a decoding product.

Within the scope of this disclosure, machine-readable codes or, in short, codes are understood to mean, for example, one-dimensional barcodes and/or multi-dimensional codes, such as a 2D code, a stacked code, a matrix code, a multi-colour code, a QR code or suchlike.

It is however conceivable that the codes are codes stored as what are termed RFID tags or NFC tags. In this case, the reader unit 40 is a reader unit for RFID or NFC tags.

The communication module 46 is designed to communicate and exchange data with the connection device 20, more specifically with the second communication module 28 of the connection device 20 by means of short-range radio technology, for example via Bluetooth, in particular Bluetooth Low Energy, or via WLAN.

The communication module 46 and in particular the entire code reader 16 is not configured, for example, to communicate with the control system 22 or the Internet directly, i.e. without an intermediate step via the connection device 20.

The control unit 44 is used to control the communication module 46, the reader unit 40 and the output means 48.

By means of the contact 36, the control unit 44 is connected to the input means 32 of the garment 18 and thus receives input from the input means 32.

In general, the control unit 44 of the code reader 16 has considerably lower computing power and a considerably smaller storage capacity than the control unit 24 of the connection device 20.

In particular, the control unit 44 of the code reader 16 is an embedded system, for example the MCU nRF7002 from Nordic Semiconductor.

Moreover, the code reader 16 has defined a configuration, the functions and the characteristics of the code reader 16. The configuration is stored, for example, as a configuration file in the control unit 44.

In addition, at least one test condition 56, in particular several test conditions 56 are stored as a set 58 of test conditions in the control unit 44, for example as part of the configuration.

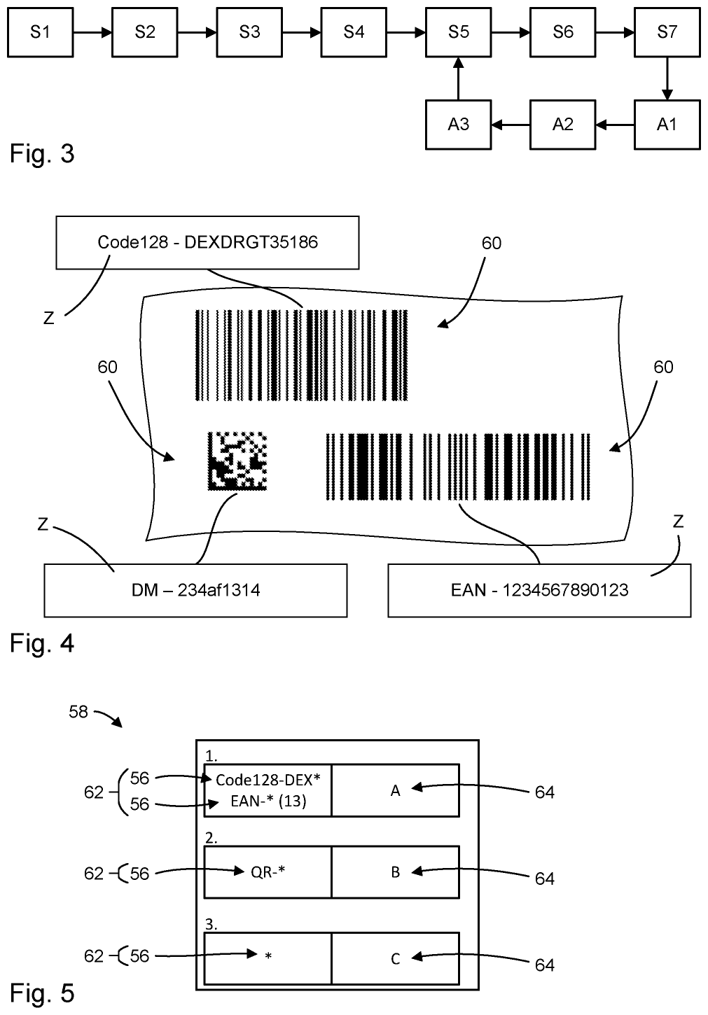

During the application of the work system 10, the method according to an embodiment of the disclosure that is shown in FIG. 3 as a flow diagram is executed. To this end, the code reader 16 is inserted into the holder 30 of the garment 18.

The garment 18 is worn in turn by the user of the work system 10.

The user actuates the input means 32 in the first step S1 in order to scan one or more codes. In the shown embodiment, the user presses the trigger.

The control unit 44 receives the input of the user and then activates the reader unit 40. After receiving this user input, the reader unit 40 now starts the reading process (step S2).

During the reading process, the reader unit 40 generates a recording of its field of view, detects at least one code in the recording and decodes this code. This means that the reader unit 40 determines the character string coded in the code as content (step S3).

In step S4, the coded character string Z is now transmitted by the reader unit to the control unit 44.

In FIG. 4 as an example, a section of a part is shown, for example a component or a good, onto which several codes 60 have been applied. In addition, the character string Z relating to each of the codes 60 is shown.

The codes 60 in FIG. 4 are different types, i.e. have a different symbology.

The type of symbology, in the shown example Code 128 (“Code 128”), data matrix (“DM”) or EAN (“EAN”), is transmitted in the shown example by the reader unit 40 to the control unit 44 as part of the character string Z in addition to the character string stored actually in code 60 as content. It is also conceivable that only the character string stored as content in code 60 is transmitted to the control unit 44.

During the reading process, more than one recording is recorded and the codes 60 are determined in these recordings. For example, recordings are generated by the reader unit 40 continuously (i.e. with a predetermined scan frequency) and the codes 60 contained therein are scanned and decoded. Thus, in each case, one character string Z is transmitted per scanned code 60 to the control unit 44.

The reading process can be executed as long as the input means 32 is being actuated by the user, for example being held down. However, the reading process can also have a predefined duration.

It is also conceivable that the reading process is ended prematurely by the control unit 44, for example by the control unit 44 sending a corresponding instruction to the reader unit 40.

In the example shown in FIG. 4, three character strings Z that each correspond to one of the codes 60 are thus transmitted to the control unit 44 and received by it.

In step S5, the control unit 44 now compares the received character strings Z with the test conditions 56.

In FIG. 5, a set 58 of test conditions is shown as an example. The set 58 of test conditions contains four different test conditions 56 that are grouped together into three groups 62.

The groups 62 and thus also the test conditions 56 are stored in a sequence in the set 58 of test conditions, in said sequence they are to be tested by the control unit 44.

In addition, an action 64 is allocated to each test condition 56 and each group 62 that is stored together with the test condition 56 or the set 58 of test conditions in the control unit 44.

The test conditions 56 specify the properties of the character string Z that the character string must comprise in order to satisfy this test condition or not. In particular, the test conditions 56 only specify properties of the character strings and thus are to be tested without any further knowledge by a simple and thus extremely rapid character comparison.

The control unit 44 can thus solely test by comparing the character string Z by means of the character comparison as to whether a test condition 56 has been fulfilled or not.

The property specified by the test condition 56 is, for example, that specific characters have to be present within the character string Z at specific positions. Also the length of the character string Z that is to be tested can be such a property and can thus be specified by the test condition.

In the set 58 of test conditions shown in FIG. 5, two test conditions 56 are contained in the first group 62.

One of these test conditions 56 requires that the character string Z starts with the character “Code 128-DEX”. Thus, a scanned code 60 must be a code 60 with the symbology “Code 128”, in whose content the first three characters are “DEX”.

The other one of the test conditions 56 of the first group 62 requires that the character string Z comprises the character “EAN” at the first three positions, thus that it is a code 60 with “EAN” symbology. In addition, this test condition requires that the character string Z has a length of 13 characters.

The action A is allocated to this group, wherein the designations “A”, “B” and “C” for the actions are selected in FIG. 5 merely for description and representation purposes.

The action A includes that the character string Z is sent by means of the communication module 46 completely and indeed in the sequence that initially the character string Z of code 60 with the symbology Code 128 is sent, and subsequently the character string Z of the code 60 with the symbology EAN.

For example, it is also stored in the action A that only the last 10 characters are sent from the character string Z of code 60 with the symbology “EAN”, thus only a part of the character string Z is sent.

In addition, the action A contains the activity that the reading process is to be ended, thus the control unit 44 is to send a corresponding instruction to the reader unit 40. The action A can also include that the reading process is to be continued. Under certain circumstances, the control unit 44 must also therefore send a corresponding instruction to the reader unit 40.

Moreover, the action A includes that the control unit 44 outputs confirmatory feedback to the user by means of the output means 48. For example, this occurs by displaying a confirmatory notification on the screen 50, generating a corresponding audio output via the loudspeaker 52 or generating a specific vibration pattern by means of the vibration motor 54.

The action A is then executed if all corresponding test conditions 56 are fulfilled by the character strings Z that have been received in the same reading process.

Thus, the character string Z that fulfils the last of the test conditions 56 is transmitted, but also further character strings that have been determined previously in the same reading process and that fulfil one of the test conditions 56 of the first group 62.

The second group 62 of test conditions comprises only one test condition 56, namely that the character string Z must start with the characters “QR”, thus that the code 60 for the character string Z must be a quick response code.

The corresponding action B provides that the character string Z is discarded, therefore is not sent by means of the communication module 46.

The action B can also provide that the control unit 44 outputs negative feedback to the user by means of the output means 48 and/or is to end the reading process.

The third group 62 of the set 58 of test conditions comprises a single test condition 56. This test condition 56 comprises all character strings Z and is thus used to be able to deal with unexpectedly scanned codes 60.

The corresponding action C provides that the character string Z is adapted. For example, three letters “X” are added to the character string Z at the end. It is also conceivable that specific characters of the character string Z are removed or are replaced with predefined characters.

Then, the action C defines that the adapted character string is sent by means of the communication module 46.

It is also conceivable that the adaptation is also undertaken for the further character strings Z that are scanned in this reading process.

In step S6, the control unit 44 now executes the activities that are contained in the actions A, B or C, whose corresponding test conditions 56 are fulfilled, i.e. whose test conditions 56 have resulted in a match during the comparison with the character string Z or character strings Z.

In particular, said one or more character strings Z or adapted character strings are sent in step S6 by means of the communication module 46.

Said one or more character strings Z are sent to the control device 14. In the event that the control device 14 is a connection device 20, the connection device 20 then transmits said one or more character strings Z to the control system 22, if applicable according to its own, more complex testing.

In the event that the control device 14 is a control system 22, it processes the received character strings Z accordingly further (step S7).

The one or more character strings Z may be sent as such individually by means of the communication module 46.

It is also conceivable that for sending the one or more character strings Z by means of the communication module 46, a plurality of character strings Z to be sent are sent together as a transport character string.

For example, a transport character string includes the one or more character strings Z which are concatenated together. It is possible that no, one or more than one additional characters are provided or added between two character strings to be sent in the transport string to separate the character strings to be sent.

For example, the associated test condition 56 specifies (for example, as an action or as part of an action) how the one or more character strings Z are to be sent, for example, whether the character strings to be sent are to be sent individually or together in a transport character string.

With respect to the character strings Z shown in FIG. 4, it is conceivable that the test condition specifies that the character string “CODE128-DEXDRGT35186” and the character string “EAN-1234567890123” are to be sent together in a transport character string. The transport character string for this case is: “CODE128-DEXDRGT35186EAN-1234567890123”.

It is conceivable that the test condition specifies additional characters, for example “-NEXT-”, to be added between the character strings Z in the transport character string as a separation. Such a transport character string would be: “CODE128-DEXDRGT35186-NEXT-EAN-1234567890123”.

The sequence of the character strings Z in the transport character string may also be specified in the associated test condition.

The test conditions 56 or the set 58 of test conditions can however also be adapted.

To this end, the control device 14 can initially create or select a new test condition 56 or a set 58 of test conditions (Step A1).

The control device 14 then transmits these test conditions 56 or the set 58 of test conditions to the control unit 44 of the code reader 16 (step A2), in particular by means of the communication module 46 of the code reader 16.

This transmission of the test conditions 56 or the set 58 of test conditions can also be carried out when transmitting a new configuration file for changing the configuration of the code reader 16. Also, the test conditions 56 or the set 58 of test conditions can be part of the content of the configuration file and thus part of the configuration.

The control unit 44 of the code reader 16 now replaces a test condition 56, all test conditions 56 or individual test conditions 56 determined by the control unit 14 or accordingly the set 58 of test conditions with the test conditions 56 or set 58 of test conditions received by the control unit 14 (step A3).

In the next execution of the step S5, i.e. the comparison of the test conditions 56 with the character string Z, the newly received test conditions 56 or the newly received set 58 of test conditions 56 are now used and these are compared with the character strings Z.

In this way, it is possible that the test conditions 56 are adapted individually to the situation in which the code reader 16 or the wearable code reading system 12 is being used.

In particular, it is conceivable that the test condition 56 or the set 58 of test conditions are replaced particularly frequently by the control device 14, for example after each completed sending of the character strings Z to the control device 14. In this way, the user of the code reading system 12 can be guided in great detail through the process to be executed, without latencies or waiting times occurring, until the user receives feedback as to whether the scanned codes 60 meet the requirements of the process.

In the discussed example, the EAN code is transmitted as the character string Z to the control device 14, among other things when scanning the code 60 shown in FIG. 4. The EAN code (and the further codes 60) is applied and identified on a good that is to be prepared for dispatch.

The user must now scan the code of a packing container as the next process step, for example, said packing container always being a code 60 with the symbology “Code128” and starts with the characters “SHIP”.

Accordingly, after receiving the character string Z of the EAN code, the control device 14 transmits new test conditions 56 to the code reader 16. It is then stored in the test conditions 56 that only codes 60 with the symbology “Code 128” and the first four characters “SHIP” are to be transmitted next to the control device 14.

In this way, the scanned codes 60 can be tested already in the code reader 16 for plausibility with the process to be executed, i.e. directly and with minimal latencies. Thus, feedback can be given to the user in real time. Feedback waiting times for the user are thus avoided, which occur, for example, via radio data transmission and data processing to the control device 14, in particular on a remote server.

In another embodiment, the testing of the character string Z is carried out via the control device 14 that in this case is a connection device 20, in particular a wearable smart device, preferably a smartphone. However, the connection device 20 can also be, for example, a tablet, a laptop, a smart watch or smart glasses.

To this end, the control device 14 is configured accordingly and comprises at least one test condition 56 and/or at least one set 58 of test conditions.

In contrast to the preceding embodiments, the reader unit 40 of the code reader 16 transmits the character string Z and/or the scanned code 60 to the control device 14 by means of the communication module 46 without being tested. For example, all codes scanned by the reader unit 40 and/or their character strings are transmitted to the control device 14.

The control device 14 then tests the character string Z in the same way as described for the previous embodiments with regard to the control device 44 of the code reader 16. Under certain circumstances, the control device 14 decodes the scanned code 60 earlier.

In this embodiment, the control device 14 assumes the testing by the control unit 44, wherein the remaining setup of the work system 10 and the sequence of the method corresponds to the setup and sequence of the embodiments previously described, in particular wherein the control device now comprises the features necessary for the testing.

The testing per se, like the properties of the test conditions 56, the type of testing, the actions and suchlike, are the same as described for the preceding embodiments.

1. A code reader for attachment to a garment, comprising a reader unit, a control unit as well as a communication module for wireless data transmission,
wherein the reader unit and the control unit as well as the control unit and the communication module have wired connections to each other,
wherein the reader unit is configured to scan a code, to decode the scanned code into a character string and to transfer the character string to the control unit, and
wherein the control unit comprises at least one of at least one test condition or one set of test conditions and is configured to receive the character string, to compare the character string with said at least one test condition, and to execute an action depending on a result of the comparison.

2. The code reader according to claim 1, wherein the action comprises one or more of the following activities:
sending at least one of the entire character string, a part of the character string, an entire further character string that has been received by the reader unit, or a part of a further character string by means of the communication module;
discarding at least one of the character string or a further character string that has been received by the reader unit;
adapting at least one of the character string or a further character string and sending the adapted character string by means of the communication module; or
sending an instruction to the reader unit to end or to continue a reading process.

3. The code reader according to claim 1, wherein adapting at least one of the character string or a further character string includes replacing one or more specific characters at a specific position in the character string.

4. The code reader according to claim 1, wherein said at least one test condition specifies at least one property of the character string.

5. The code reader according to claim 4, wherein one of the at least one test condition specifies one or more specific characters at a specific position in the character string and/or a length of the character string.

6. The code reader according to claim 4, wherein said at least one control unit is configured to compare said at least one test condition via character comparison of the character string with the test condition.

7. The code reader according to claim 1, wherein several test conditions are grouped together into different groups of test conditions.

8. The code reader according to claim 1, wherein a sequence is stored in the control unit in which at least one of the test conditions or groups of test conditions are to be tested.

9. The code reader according to claim 1, wherein the control unit is configured to receive at least one of at least one further test condition, or action, or a further set of test conditions by means of a communication module.

10. The code reader according to claim 1, wherein the action is at least one of part of the set of test conditions or stored together with the associated test condition in the control unit.

11. The code reader according to claim 1, wherein the code reader is at least one of a one-piece device or the code reader comprises a housing in which the reader unit and the control unit are located.

12. The code reader according to claim 1, wherein the reader unit is configured to scan several codes after activation of a reading process, to decode the scanned codes each into a character string and to transfer the character strings to the control unit.

13. The code reader according to claim 12, wherein at least one of one of the actions or the set of test conditions define a sequence in which character strings are to be sent by means of the communication module, and the control unit is configured to send the character string in that sequence.

14. The code reader according to claim 1, wherein the reader unit is configured to start a reading process after receiving a user input.

15. The code reader according to claim 1, wherein the code reader comprises an output means, wherein the control unit is configured to output as an action an output to a user by means of the output means.

16. A work system comprising a code reader and a control device,
wherein the code reader comprises a reader unit, a control unit as well as a communication module for wireless data transmission,
wherein the reader unit and the control unit as well as the control unit and the communication module have wired connections to each other,
wherein the reader unit is configured to scan a code, to decode the scanned code into a character string and to transfer the character string to the control unit, and
wherein the control unit comprises at least one of at least one test condition or one set of test conditions and is configured to receive the character string, to compare the character string with said at least one test condition, and to execute an action depending on a result of the comparison, and
wherein the work system is configured so that the code reader sends a character string to the control device by means of the communication module.

17. The work system according to claim 16, wherein the control device is at least one of a control system or a connection device.

18. The work system according to claim 16, wherein the control device is configured to transmit at least one of single test conditions, actions or a set of test conditions to the code reader, and the code reader is configured to apply at least one of the received test condition or the received set of test conditions for the comparison.

19. The work system according to claim 16, wherein the work system comprises a garment that has an input means for the code reader.

20. A work system comprising a code reader for attachment to a garment and a control device that is a connection device, wherein the code reader comprises a reader unit as well as communication module for wireless data transmission,
wherein the code reader is configured to at least one of scan a code, to decode the scanned code into a character string and to send the character string to the control device by means of the communication module, or to scan a code and to send the scanned code to the control device by means of the communication module, and
wherein the control device comprises at least one of at least one test condition or one set of test conditions and is configured to at least one of receive the character string or receive the scanned code and to decode the scanned code into a character string, to compare the character string with at least one test condition, and to execute an action depending on a result of the comparison.
